(19) United States
(12) Patent Application Publication
(10) Pub. No.: US 2012/0046880 A1
(43) Pub. Date: Feb. 23, 2012

(54) System and Method for Creating and Processing Data Validation Rules for Environmental or Non-anthropogenic Data

(75) Inventor: Steven P. Drevik, Knoxville, TN (US)

(73) Assignee: Agilaire, LLC, Knoxville, TN (US)

(21) Appl. No.: 13/281,545

(22) Filed: Oct. 26, 2011

Related U.S. Application Data
(63) Continuation-in-part of application No. 12/020,940, filed on Jan. 28, 2008.
(60) Provisional application No. 60/898,043, filed on Jan. 29, 2007.

(51) Int. Cl. G06F 19/00

(52) U.S. Cl. 702/24

(57) ABSTRACT

A system and method for validation of data about non-anthropogenic processes acquired without human input. The method includes comparisons of data relating to physical or chemical processes or known limiting factors, or of similar measurements at other representative locations. The present invention provides a graphical user interface to allow the definition of an unlimited number of rules, with the option for spatial specificity, for automatically tabulating data using a computer program or other processing mechanism, with various actions performed on the data based on the results and defined by the user.

### CROSS-REFERENCE TO RELATED APPLICATIONS

This application claims the benefit of U.S. patent application Ser. No. 12/020,940, filed Jan. 28, 2008, which claims the benefit of U.S. Provisional Application No. 60/898,043, filed Jan. 29, 2007.

### STATEMENT REGARDING FEDERALLY-SPONSORED RESEARCH OR DEVELOPMENT

Not Applicable

### BACKGROUND OF THE INVENTION

1. Field of Invention

The present invention relates to a system and method for validating ambient air quality and meteorological measurements. More specifically, the present invention relates to such a system and method by comparing measured ambient air quality and meteorological values against other measured or known values from physical processes, chemical processes, or other representative measurements.

2. Description of the Related Art

State and local air monitoring agencies, industry, and consultants automatically acquire a significant amount of data about air quality and meteorology. These measurement sites run unattended, so remotely retrieved data must be reviewed to find instrument failures or note other special conditions that may be required for later reporting. For example, a special condition may be a wildfire or controlled burns affecting particulate measurements of ambient air. Such special conditions, without knowledge of the special condition, might otherwise indicate instrument failure or inaccurate public health warning. Currently this work is being performed manually, with the validation algorithms primarily known only by the individual charged with the data validation task. As the data is already in digital form and in the database of a computer, a method for the user to define their mental guidelines and apply those rules automatically would greatly improve the efficiency, accuracy, and repeatability of the data validation process.

Other devices and methods have been provided for data validation. Typical of the art, however, are those devices and methods whereby data in the input process is validated against human error, as opposed to being validated automatically against non-anthropogenic conditions or chemical interactions. Typically, conditions are manually input with no ability to detect slight changes in condition, such as temperature, ozone level, or the like.

### BRIEF SUMMARY OF THE INVENTION

The present invention is a system and method for validating ambient air quality and meteorological measurements by comparing measured values against known benchmark values. In order to accomplish data validation, the present invention provides a user-friendly, computer-based system and method for quickly and easily creating validation rules for automated measurements. A graphical user interface (GUI) form allows the user to define a logical combination of conditions into a trigger, and to define the consequences of those conditions being met. This logical combination of conditions is used to formulate a rule.

A host computer is provided for data processing, and specifically for data validation. Data is collected at one or more site locations and from one or more data collection devices. Meteorological data collection devices include, but are not limited to, a wind speed indicator, a wind direction indicator, a temperature sensor, a solar radiation detector, and a rainfall indicator. Ambient air data collection devices include, but are not limited to, an ozone detector, a temperature sensor, a solar radiation detector, a carbon monoxide sensor, a nitrogen oxide sensor, sulfur dioxide sensor, a hydrocarbon sensor, an air particulate sensor, and an ammonia sensor. Each of the data collection devices is in communication with the host computer for data validation. Data from a single data collection device is compared either to a clock as a time-of-day analysis and/or to historical data for that data collection device. When data from a plurality of data collection devices is used for data validation, data from different data collection devices at the same site are used, or data from the same data collection devices at different sites are used.

The Rule Definition form defines a Trigger window and an Action window. Within the Trigger window is displayed a Trigger definition. Similarly, within the Action window is displayed an Action definition. The Trigger window and the Action window essentially function to graphically display a logical IF-THEN statement, with the Trigger window defining the IF statement and the Action window defining the THEN statement.

The Trigger definition allows a user to define one or more comparisons, with each comparison being joined and nested so that comparisons can be joined into a single logical expression. For each comparison, the user defines the source of the data for comparison, what properties or statistical calculation of the data source should be considered for evaluation, against what to evaluate, and the nature of the comparison itself. Between successive comparisons, logic operator field is provided in order to determine the nesting of the comparisons. The logical operators function in a conventional manner in order to determine whether the IF statement is TRUE.

The Action window allows the user to define any number of actions to take if the data collected meets the criteria of the Trigger condition. If the trigger condition is met, then the defined action(s) is(are) performed.

Each of the Trigger window and the Action window includes input controls for adding and deleting terms and parameters, making the system customizable and updatable. The form also includes selection tools for the user to save the rule, delete the rule, search for a particular rule, or to scroll through the list of rules. Each rule form also includes a selection to allow for the temporary or permanent suspension of the rule, allowing the user to take a rule out of action without deleting the definition itself.

In the method of the present invention, a set of rules is input into the host computer. The rules are analyzed automatically and sequentially. To begin a data validation test, a rule is first loaded. Each comparison within the Trigger definition is made as directed by the logical operators. At any point during the comparisons, if it is determined that the criteria have not been met, the next rule is loaded and the comparisons in that trigger definition are made. If all of the criteria have been met to determine that the Trigger definition has been met, then the action(s) to be taken is(are) determined and taken. The next rule is then loaded and tested.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a schematic diagram of a system including various features of the present invention including a plurality of data collection devices located at each of two sites and in communication with a host computer for data validation;

FIG. 2 is a sample of the Rule Definition form for user input of the rule showing a Trigger window and an Action window;

FIG. 3 is a flow diagram used to evaluate a rule displayed in the Rule Definition form of FIG. 2, wherein three comparisons connected with the logical operator AND are utilized;

FIG. 4 is a portion of a flow diagram used to evaluate an alternative rule, wherein two comparisons connected with the logical operator OR are utilized;

FIG. 5 is a portion of a flow diagram used to evaluate a further alternative rule, wherein a first comparison is connected to second and third comparisons with the logical operator AND, and wherein the second and third comparisons are connected with the logical operator OR; and

FIG. 6 is a schematic diagram of another embodiment of a system including various features of the present invention including a plurality of air quality data collection devices located at each of two sites and in communication with a host computer for data validation.

### DETAILED DESCRIPTION OF THE INVENTION

The present invention is a system and method for validating ambient air quality and meteorological measurements by comparing measured values against known benchmark values. The benchmark values are derived from physical processes, chemical processes, and other representative measurements. Rules are applied to the measured values to make a comparison with the benchmark values and to alert a user when an anomaly has been detected. Depending upon the rule being analyzed, a user determines whether the anomaly is real or is a function of a faulty detector. In so doing, the system is provided for monitoring the integrity of the components within the system.

Benchmark data is collected using components within the system, or is acquired from known data. With respect to physical processes, certain environmental processes have known values. For example, solar radiation at night is zero. Similarly, with respect to chemical processes, ambient air ozone, for example, should be less than some site-specific value when the temperature is below 72° F. With respect to other representative measurements, it is known that the wind speed at two nearby sites, for example, should not vary significantly.

In order to accomplish data validation, the present invention provides a user-friendly, computer-based system and method for quickly and easily creating validation rules for automated measurements. A graphical user interface (GUI) form allows the user to define a logical combination of conditions into a trigger, and to define the consequences of those conditions being met. This logical combination of conditions is used to formulate a rule. In simple form, if sensor A measures a value of X and sensor B measures a value of Y, then the value of C should be Z. In this simplified rule, Z may be either of a static number, the lower limit of a range of numbers (equal to or greater than Z), the upper limit of a range of numbers (equal to or less than Z), or a range of numbers (between Z₁ and Z₁). When the actual measured value of C meets the criteria for Z, then it is determined that the data collected by the system is valid. After the rules have been defined in the system, data collection and validation is automatically performed.

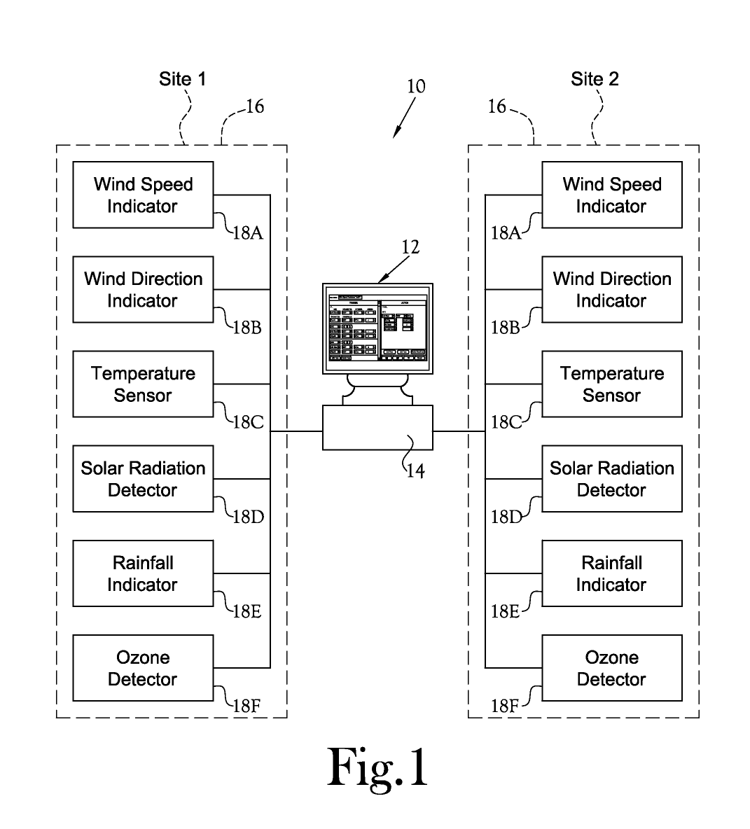

FIG. 1 illustrates a schematic diagram of a system, illustrated at 10, of the present invention. A host computer 12 is provided for data processing, and specifically for data validation. The computer 12 is provided with a data processor, memory and at least one user input, illustrated collectively at 14. Data is collected at one or more site locations 16 and from one or more data collection devices 18. In one embodiment, such as the embodiment illustrated in FIG. 1, the data collection devices 18 include a wind speed indicator 18A, a wind direction indicator 18B, a temperature sensor 18C, a solar radiation detector 18D, a rainfall indicator 18E, and an ozone detector 18F. In another embodiment, such as the embodiment illustrated in FIG. 6, the data collection devices 18 include chemical sensors to identify data pertaining to air quality, such as for example a carbon monoxide indicator 18A′, a nitrogen oxide indicator 18B′, a temperature sensor 18C′, a solar radiation detector 18D′, a rainfall indicator 18E′, and an ozone detector 18F′. It will be understood that more, fewer, or different data collection devices 18 may be incorporated into the system of the present invention. Each of the data collection devices 18 is in communication with the host computer 12 for data validation. Typically, data from a single data collection device 18 is compared either to a clock as a time-of-day analysis (e.g., solar radiation for a given time of day), and/or to historical data for that data collection device (e.g., ozone level compared to historical ozone level at this time of day and on this day of the year). When data from a plurality of data collection devices 18 is used for data validation, data from different data collection devices 18 at the same site are used (e.g., wind speed and wind direction; solar radiation detector and rainfall rate), or data from the data collection devices 18 at different sites 16 (e.g., comparison of temperatures, solar radiation levels, ozone levels, etc., between sites that should have comparable results for each) are used.

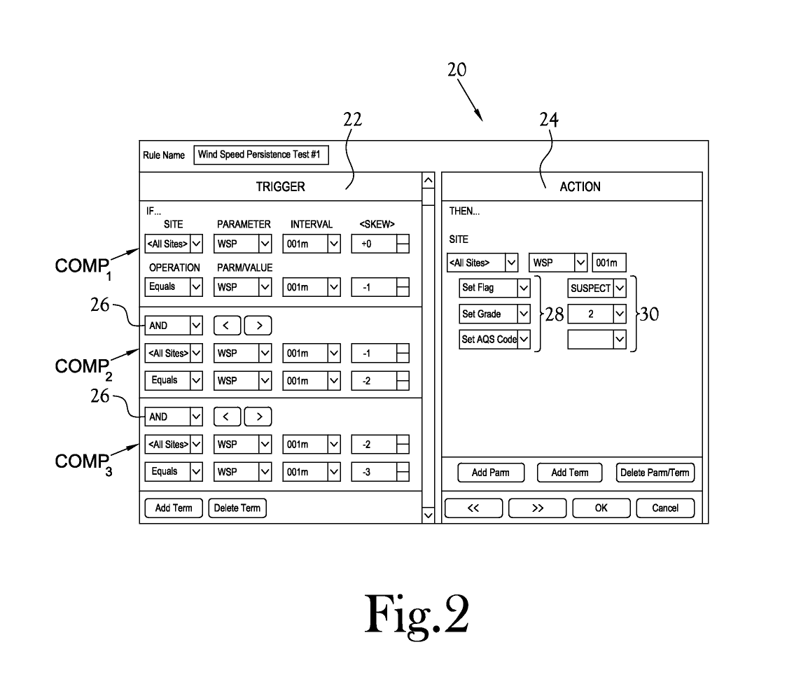

Illustrated in FIG. 2 is a sample Rule Definition form 20 for user input of a rule. It will be understood that this is only one example, and the format and number, position and presentation of the various fields is application-specific. Accordingly the exemplary illustration is not intended to limit the scope of the present invention. In the illustrated embodiment, the Rule Definition form 20 defines a Trigger window 22 and an Action window 24. Within the Trigger window 22 is displayed a Trigger definition. Similarly, within the Action window 24 is displayed an Action definition. The Trigger window 22 and the Action window 24 essentially function to graphically display a logical IF-THEN statement, with the Trigger window 22 defining the IF statement and the Action window 24 defining the THEN statement.

The Trigger definition allows a user to define one or more comparisons COMPₓ, with each comparison COMPₓ being joined and nested so that comparisons COMPₓ can be joined into a single logical expression. For each comparison, the user defines the source of the data for comparison, what properties or statistical calculation of the data source should be considered for evaluation, against what to evaluate, and the nature of the comparison itself. In the illustrated embodiment, three comparisons COMP₁, COMP₂, and COMP₃ are illustrated within the Trigger window 22. Elements included in this illustration are SITE, PARAMETER, INTERVAL, and SKEW. Each element includes a drop-down window in order to select from a predetermined set of options. The SITE parameter, for example is selected as “<All Sites>”, but may include selections from the list Site 1, Site 2, and so forth. It will be understood that this and all other elements are customized to suit the needs of the particular implementation.

The PARAMETER element selected is WSP, or Wind Speed Persistence. Other PARAMETER elements include, but are not limited to, ozone, carbon monoxide, nitrogen oxide, sulfur dioxide, hydrocarbons, air particulate, ammonia, ambient temperature, solar radiation, wind speed, wind direction, pressure and time, as well as statistical arguments of these elements including, but not limited to, historical average and standard deviation. The interval unit is appropriately selected for the particular parameter element. In the illustrated embodiment, the interval is selected as 001 m. The SKEW is selected as an allowable deviation of the parameter. The OPERATION field is a mathematical operator selected from a group consisting of at least: equal to (=); less than (<); less than or equal to (≦) greater than (>); greater than or equal to (≧); approximately (≈); and not equal to (≠).

In the illustrated example, three comparisons are shown. Between successive comparisons, logic operator field 26 is provided in order to determine the nesting of the comparisons. The logic operator 26 includes, but is not limited to: AND, OR, ANDOR, and ANDNOT. The logical operators 26 function in a conventional manner in order to determine whether the IF statement is TRUE.

The Action window 24 allows the user to define any number of actions to take on the data. If the trigger condition is met, i.e., the IF statement is TRUE, then the THEN statement is performed. In the example, the Action window 24 includes a plurality of elements, including SITE, PARAMETER, INTERVAL, and a plurality of ACTION windows. The Action window 24 allows a user to determine a particular action to take from a primary set of actions 28, as well as from a secondary subset of actions 30. The primary set of actions 28 are typically chosen as a result of the Trigger definition having been met for a particular test, and the secondary subsets of actions 30 are chosen as a result of, for example, the degree and frequency of the Trigger definition having been met. For example, if the test includes monitoring temperature, a one-time variation of two degrees (2°) over a baseline temperature might result in a lower degree of action than if the variation were repeatedly measured at ten degrees (10°) over baseline.

In the illustrated primary set of actions 28, included are “Set Flag,” “Set Grade,” and “Set AQS Code.” Under “Set Flag,” the chosen secondary action 30 is “SUSPECT,” indicating that the data collected and compared in the Trigger window 22 is suspect. Thus, a user would suspect that wind speed sensors used to collect the data are faulty, and inspection of the sensors is warranted. In some circumstances, the results are collected to determine if subsequent comparisons COMPₓ yield another flag, which can be used as another comparison COMPₓ in the Trigger window 22, and can affect the level of the flag. Also in the illustrated embodiment, the “Set Grade” level is determined to be “2.” Again, the degree and frequency at which the Trigger definition is met can be used to determine which of the secondary subsets of actions to be taken.

Each of the Trigger window 22 and the Action window 24 includes input controls for adding and deleting terms and parameters, making the system 10 customizable and updatable. The form also includes selection tools for the user to save the rule, delete the rule, search for a particular rule, or to scroll through the list of rules. Each rule form also includes a selection to allow for the temporary or permanent suspension of the rule, allowing the user to take a rule out of action without deleting the definition itself.

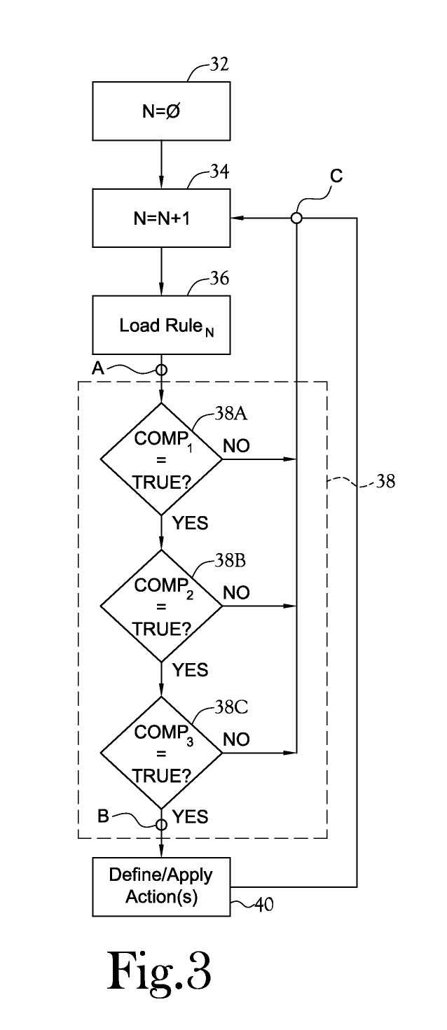

FIG. 3 illustrates a simplistic flow diagram for the validation process of the present invention using rules such as that illustrated in FIG. 2. Initially, N is set to 0 at 32. N is incremented by 1 at 34 throughout the process, with each value of N representing a rule or test definition. Each test is monitored in succession, and automatically. After N has been incremented, the particular rule R_{N} is loaded at 36. Each comparison COMPₓ is then evaluated according to the rule at 38. In the example of FIG. 2, there are three comparisons COMPₓ, COMPₓ, and COMPₓ, each linked with the logical operator “AND” 26. Therefore, in the flow diagram of FIG. 3, there are three comparisons 38A, 38B, and 38C. If COMP₁ is not TRUE, then the test is not met, and N is incremented and the next test is performed. If COMP₁ is TRUE, then COMP₂ is made. If COMP₂ is TRUE, then COMP₃ is made. COMP₃ is TRUE, then the selected action(s) depicted in the Action window 24 is(are) performed. Because each of the comparisons COMP₁, COMP₂, and COMP₃ is linked to the next by the logical operator “AND” 26, if any of the three is not TRUE, then the test is not met and no action is required.

Illustrated in FIG. 4 is an alternative embodiment 38′ wherein two comparisons COMP₁ and COMP₂ are made and are connected with the logical operator “OR” 26. In this embodiment, if COMP₁ is TRUE, then the selected action(s) is(are) taken and evaluation of COMP₂ is not required. If COMP₁ is not TRUE, then evaluation of COMP₂ is made. Action is taken only if one of COMP₁ or COMP₂ is TRUE.

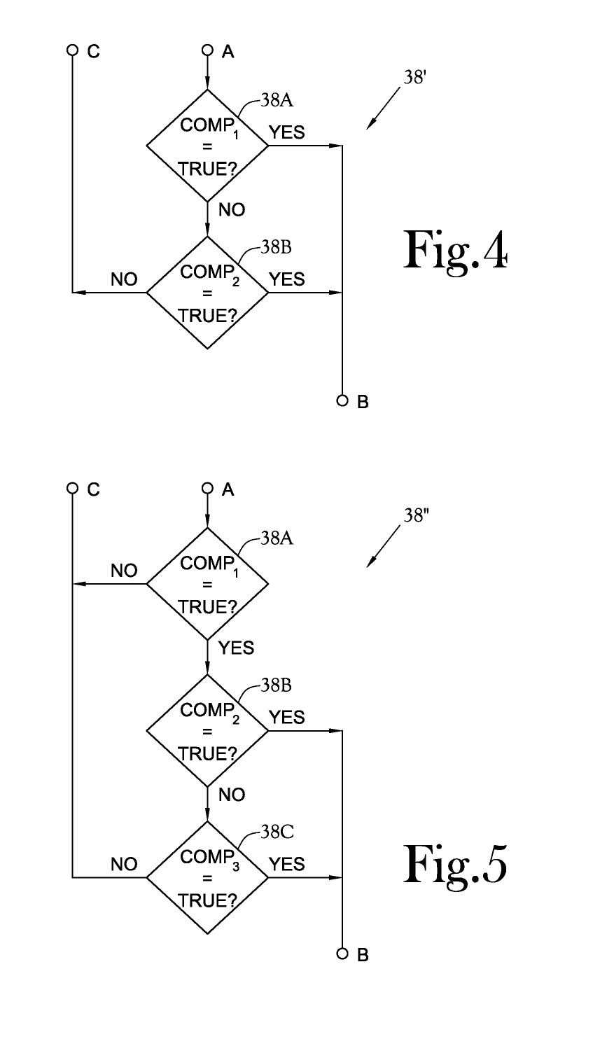

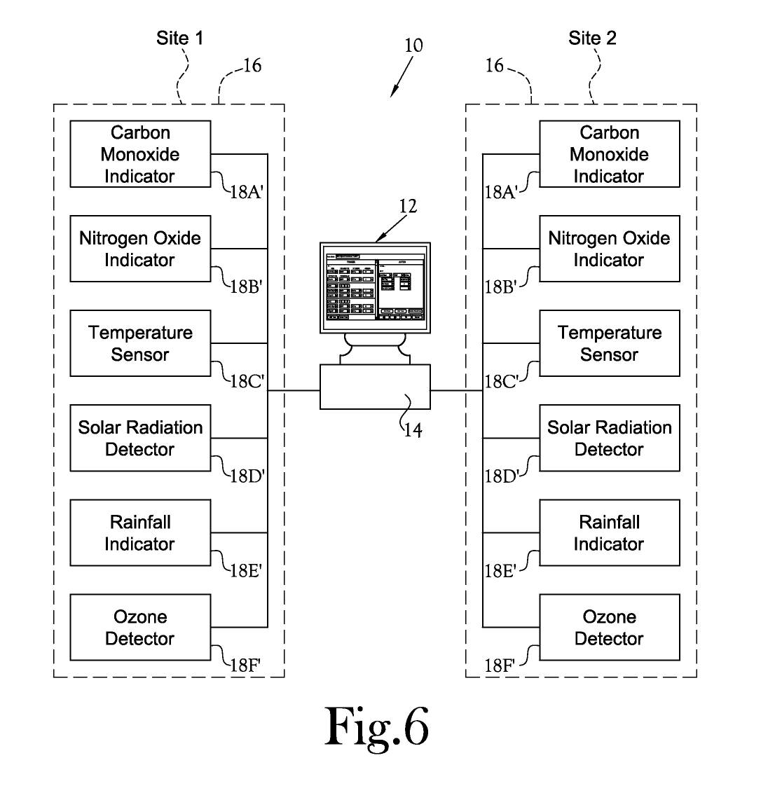

FIG. 5 illustrates yet another alternative embodiment 38″ of the portion of the flow diagram wherein three comparisons COMP₁, COMP₂ and COMP₃ are made, with the second and third comparisons COMP₂ and COMP₃ are connected to the first COMP₁ with an “AND” and to each other with an “OR.” In logical expression, this relationship is defined by COMP₁ AND (COMP₂ OR COMP₃). In this example, if COMP₁ is not TRUE, then R_{N} is incremented and the next rule evaluated. If COMP₁ is TRUE, then COMP₂ is evaluated. If COMP₂ is TRUE, then the selected action(s) is(are) taken and evaluation of COMP₃ is not required. If COMP₂ is not TRUE, then evaluation of COMP₃ is made. Action is taken only if COMP₁ and either of COMP₂ and COMP₃ is TRUE.

The illustrated rule is provided for determining when abnormal wind speeds have been detected, indicating a potential failure of a wind speed detector. Other sample rules useful in the present invention include, but are not limited to:
Detection of the ozone level being greater than a threshold level X when the ambient temperature is below a threshold level Y. In logical notation, this rule is defined by: OZONE>X AND AMBIENT_TEMPERATURE<Y
Any parameter value differing by a selected percentage X (X%) from a historical composite average composed of averages from the average of previous Y years, during the same hour and same day, or +/−N days
Detection of solar radiation above a threshold level X during nighttime hours, when solar radiation should be close to zero. In logical notation, this rule is defined by: SOLAR_RADIATION>X
Detection of solar radiation below a threshold level Y during daytime hours. In logical notation, this rule is defined by: SOLAR_RADIATION<Y
Detection of solar radiation above a threshold level X during rain, and when the rainfall rate is detected above a threshold level Y, when solar radiation should be close to zero. In logical notation, this rule is defined by: SOLAR_RADIATION>X AND RAINFALL_RATE>Y
Detection of wind speed above a threshold level X while the wind direction standard deviation is detected above a threshold level Y. It is known that large wind direction changes occur at low wind speeds. In logical notation, this rule is defined by: WIND_SPEED>X and WIND_DIRECTION_STANDARD_DEVIATION>Y

It will be understood that these are provided as examples only, and that the present invention is not limited to or by these examples.

From the foregoing disclosure, a system and method for data validation, such as for example ambient air quality or meteorological data validation, has been provided. Data validation in the present invention as illustrated in the provided examples utilizes data that is automatically acquired. The data is then compared against non-anthropogenic conditions. The system provides for the comparison of a plurality of conditions and, in the event the conditions of the rule are met, certain actions are taken. Primarily, the rules are defined such that the integrity of the data collection devices is monitored. Specifically, when the conditions of a rule have been met, such is an indication that one or more data collection devices, sensors, monitors, or the like, is defective. Such data validation methods are preferred over the prior art methods which attempt to validate the input process against human errors.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A system for validating ambient air data by comparing measured values against known benchmark values, said system including:
a data processor;
a plurality of air quality data collection devices in communication with said data processor, said plurality of air quality data collection devices provided for collecting ambient air quality data from non-anthropogenic chemical interactions; and
a graphical user interface in communication with said data processor, said graphical user interface being configured to allow a user to program said data processor to define at least one condition of the collected ambient air quality data to establish a user-programmed validation rule for determining whether the collected ambient air quality data is valid;
said data processor being adapted to validate the collected data by comparing the collected data with the user-programmed validation rule, and whereby said data processor indicates at least one action to be taken when said user-programmed validation rule determines invalidity of the collected ambient air quality data.

2. The system of claim 1 wherein said plurality of air quality data collection devices includes at least one data collection device selected from the group consisting of at least a temperature sensor, a solar radiation detector, an ozone detector, a carbon monoxide sensor, a nitrogen oxide sensor, sulfur dioxide sensor, a hydrocarbon sensor, an air particulate sensor, and an ammonia sensor.

3. The system of claim 2 wherein said plurality of data collection devices includes at least two sets of data collection devices, wherein each of said at least two sets of data collection devices is located at a unique location with respect to each other of said at least two sets of data collection devices, and wherein each of said at least two sets of data collection devices includes substantially similar of said at least one data collection device.

4. The system of claim 1, wherein said plurality of air quality data collection devices includes at least a temperature sensor, a solar radiation detector, an ozone detector, a carbon monoxide sensor, a nitrogen oxide sensor, sulfur dioxide sensor, a hydrocarbon sensor, an air particulate sensor, and an ammonia sensor.

5. The system of claim 1 wherein said known benchmark values are selected from values derived from chemical processes.

6. The system of claim 1 wherein said graphical user interface allows a user to define a logical combination of conditions into a trigger, and to define consequences of said logical combination of conditions being met, said logical combination of conditions being used to formulate said user-programmed validation rule.

7. A method for validating ambient air data by comparing measured values against a user-programmed validation rule, said method performed using a system including a data processor associated with memory, at least one input device including a graphical user interface in communication with the data processor and configured to allow a user to define at least one condition of a measurement to establish a user-programmed validation rule for determining whether the measurement is valid, and a plurality of air quality data collection devices in communication with said data processor, said plurality of air quality data collection devices provided for collecting ambient air quality data from non-anthropogenic processes, said method including the steps of:
a) inputting a user-defined condition of a measured value;
(b) inputting at least one validation rule into said memory, said at least one validation rule including at least one comparison of the measured value to the user-defined condition of the measured value, said at least one validation rule further defining at least one action to be taken in the event that said measured value meets criteria defined by said at least one comparison;
c) collecting a measured value using at least one of said plurality of air quality data collection devices;
d) comparing said measured value with said user-defined condition using said at least one validation rule; and
e) indicating at least one action to be taken when said at least one rule determines at least one of said air quality data collection devices is potentially faulty as indicated by said measured value meeting selected criteria of said at least one validation rule.

8. The method of claim 9, wherein each of said plurality of air quality data collection devices is defined by a chemical sensor.

9. The method of claim 8, said plurality of air quality data collection devices including at least a temperature sensor, a solar radiation detector, an ozone detector, a carbon monoxide sensor, a nitrogen oxide sensor, sulfur dioxide sensor, a hydrocarbon sensor, an air particulate sensor, and an ammonia sensor.

10. The method of claim 7, in said step b) of inputting at least one validation rule into said memory, said at least one comparison including a plurality of comparisons logically connected with logical operators, whereby said step e) of indicating at least one action is performed only when said plurality of comparisons are made in combination and in order determined by said logical operators.

11. The method of claim 8 wherein said a graphical user interface includes a rule definition form defining a trigger window and an action window, said trigger window illustrating said logically connected plurality of comparisons, said action window illustrating said at least one action, whereby said step a) of inputting at least one validation rule includes the steps of:
i) defining each of said plurality of comparisons; and
ii) defining each of said at least one action.
